(19) United States
(12) Patent Application Publication
(10) Pub. No.: US 2021/0081850 A1
(43) Pub. Date: Mar. 18, 2021

(54) MANAGING ELECTRONIC TICKET TRANSFERS

(71) Applicant: International Business Machines Corporation, Armonk, NY (US)

(72) Inventors: Robert E. Loredo, North Miami Beach, FL (US); Paul R. Bastide, Ashland, MA (US); Liam S. Harpur, Dublin (IE); Jonathan D. Dunne, Dungarvan (IE)

(21) Appl. No.: 16/574,408

(22) Filed: Sep. 18, 2019

(51) Int. Cl. G06Q 10/02; G06Q 20/32; G06Q 20/04; G06Q 30/02

(52) U.S. Cl. CPC G06Q 10/02; G06Q 30/0206; G06Q 20/045; G06Q 20/325

(57) ABSTRACT

A set of ticket transfer data associated with a user is monitored. A user profile to store the set of ticket transfer data is generated. A risk score for the user is calculated, based on the user profile. A ticket transfer attempt by the user is detected. Based on the risk score, the ticket transfer attempt is determined to meet a set of transfer criteria. The ticket is posted for transfer, and the user profile is updated, according to the ticket transfer attempt.

### BACKGROUND

The present disclosure relates generally to the field of transferring electronic assets, and more particularly to managing the transfer of electronic tickets.

Electronic tickets for a wide variety of events are available for purchase both online and at retail establishments. The subsequent transfer of such tickets may impact the market for tickets, the reputation of venues, artists, vendors, etc. The ability of an event-goer to enjoy a particular event may also be impacted subsequent transfers.

### SUMMARY

Embodiments of the present disclosure include a method, computer program product, and system for enhancing target class analysis.

A set of ticket transfer data associated with a user is monitored. A user profile to store the set of ticket transfer data is generated. A risk score for the user is calculated, based on the user profile. A ticket transfer attempt by the user is detected. Based on the risk score, the ticket transfer attempt is determined to meet a set of transfer criteria. The ticket is posted for transfer, and the user profile is updated, according to the ticket transfer attempt.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates an example network environment for a transfer controller, in accordance with embodiments of the present disclosure.

FIG. 2 illustrates an example of a user profile, in accordance with embodiments of the present disclosure.

FIG. 3 illustrates a flowchart of a method for managing electronic ticket transfer, in accordance with embodiments of the present disclosure.

FIG. 4 illustrates a flowchart of a method for adjusting a ticket transfer attempt, in accordance with embodiments of the present disclosure.

FIG. 5 depicts a cloud computing environment according to an embodiment of the present disclosure.

FIG. 6 depicts abstraction model layers according to an embodiment of the present disclosure.

FIG. 7 illustrates a high-level block diagram of an example computer system that may be used in implementing some embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of transferring electronic assets, and more particularly to managing the transfer of electronic tickets. While the present disclosure is not necessarily limited to such applications, various aspects of the disclosure may be appreciated through a discussion of various examples using this context.

Embodiments of the present disclosure provide techniques for managing the transfer of electronic tickets. Traditional techniques fail to consider historical information regarding ticket resellers, which may provide an indication as to whether the reseller has a reputation for fair dealing. Further, traditional methods fail to employ immutable ledgers and other techniques that may provide enhanced means for combatting scalping and fraud in ticket resale and transfer.

A transfer controller may collect a variety of data for a ticket reseller to construct a user profile. The profile may contain, for example data regarding the tickets the user has purchased, the original price for those tickets, the market value for the tickets, the main act (e.g., the headlining band/singer, or the sporting event, or the headlining comedian or other artist/entertainer, etc.) The user profile may further include data collected from the user's social media accounts and Global Positioning System (GPS) data from one or more devices associated with the user. The user profile may include information for multiple tickets (e.g., a historical record of several tickets purchased and/or resold by the user) over a given time period.

Using the information contained in the user profile, the transfer controller may infer and/or generate additional information. For example, by comparing an original purchase price with a resale price, the transfer controller can determine the price change (e.g., the profit made by the reseller).

By analyzing the collective data both in the user profile and inferred by the data within the user profile, the transfer controller can calculate a risk score for the user. The risk score may be used as an indicator of whether the user has a history (or a potential) of scalping/gouging/touting. The risk score may indicate a set of transfer criteria (e.g., resale price, a restricted number of resale transactions allowed, etc.) that would keep the number and severity of scalping/gouging/touting events to a minimum. The set of transfer criteria may be used by ticket transfer platforms (e.g., websites used for ticket purchase and/or resale) to reject an attempt to buy up a given number of tickets for an event (e.g., to prevent the event from selling out to ticket scalpers), or to reject an attempt to resell a ticket at a profit margin that could be considered scalping/gouging/touting.

In some embodiments, a transfer controller may provide suggestions to a user when a transfer attempt (e.g., ticket resale or purchase) is rejected. Using the risk score and set of transfer criteria, the transfer controller may suggest ranges or adjustments to the transfer attempt that would bring the attempt into an acceptable range and allow the transaction to proceed. In some embodiments, a transfer controller may forecast or predict the impact that the current transfer will have on the user's risk score going forward, which may provide an incentive to the user to avoid gouging/scalping/touting.

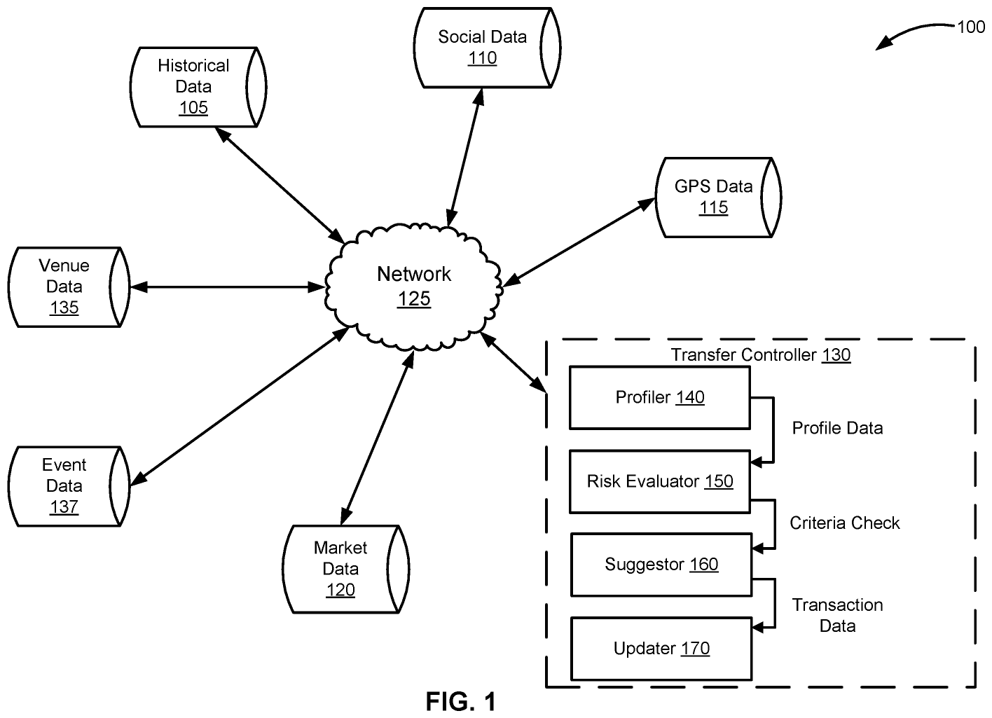

Referring now to FIG. 1, illustrated is an example network environment 100 for a transfer controller 130, in accordance with embodiments of the present disclosure. Example network environment 100 may include a transfer controller 130, a network 125, and a plurality of data sources for historical data 105, social data 110, GPS data 115, market data 120, venue data 135, and event data 137.

In certain some embodiments, the data sources may reside in the storage of a single device, or may be distributed across the storage of a plurality of devices. Data collected from the data sources may include real-time data and/or previously recorded data for the data source. In some embodiments, a single type of data (e.g., market data 120) may reside in the storage of a single device, or may reside in the storage of several devices connected either locally or remotely via a network, such as network 125. For example, the network 125 may be a wide area network (WAN), a local area network (LAN), an internet, or an intranet. For example, the transfer controller 130 and one or more data sources may communicate using a local area network (LAN), one or more hardwire connections, a wireless link or router, or an intranet. In some embodiments, the transfer controller 130 and one or more data sources may be communicatively coupled using a combination of one or more networks and/or one or more local connections.

In some embodiments, the network 125 can be implemented within a cloud computing environment or using one or more cloud computing services. Consistent with various some embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 125.

The various data sources (e.g., historical data 105, social data 110, GPS data 115, market data 120, event data 137, and venue data 135) may include data necessary for the generation of user profiles, risk scores, transfer criteria, etc. Data within the various data sources is collected and stored in accordance with privacy laws and regulations (e.g., the GDRP) and with the consent of the user(s). For example, historical data 105 may include information regarding one or more user's former ticket transfers (e.g., purchases, resales, etc.). In embodiments, historical data 105 may include original purchase price, resale price, venue information, event information, etc. Historical data 105 may include information also stored in other data sources, or information that was once stored in other data sources.

Social data 110 may include information gathered from a user's social media accounts. In embodiments, this information may be used to determine whether the user attended the event in question (e.g., an image or written post indicating attendance), whether the user intends to resell or otherwise transfer a ticket (e.g., a post soliciting friends or acquaintances regarding a resale or giveaway), to inform information regarding the market value of the ticket (e.g., posts/discussions regarding the value of tickets), etc.

GPS data 115 may include timestamps (e.g., a date, a time, a combination date and time, etc.) and location data for one or more device associated with a user. GPS data 115 may be used to determine whether a user attended an event (e.g., checking GPS coordinates against venue coordinates at the time of an event).

Market data 120 may include information regarding the value of a given ticket. Market data 120 may include information from websites, newspaper listings, ticket vendors, ticket reseller postings, etc. to inform a determination regarding the purchase price, face value, and/or market value for a given ticket.

Event data 137 may include information regarding events. Events may include, for example, a music concert, a sporting event or competition, a comedy show, an educational seminar or event, an art show or exhibit, or any other event for which tickets, tokens, e-tickets, etc. are used for entry and/or attendance. Event data 137 may include a measure of popularity of a headlining act, and/or secondary acts, as well as a measure of market supply and demand for the performing artists/acts/teams featured at the event. Event data 137 may include a measure for determining the impact of a class of events (e.g., music concerts vs. sporting events, vs. comedy shows, etc.) Event data 137 may be gathered from news sources, aggregate or other data from social media sites, from merchandise sales information (e.g., album sales, team jersey sales, and other merchandise associated with an artist/act/team, etc.).

Venue data 135 may include information regarding the location, capacity, popularity, amenities offered both within and adjacent to a particular stadium/theatre/convention center/etc. For example, two adjacent theatres may have differing popularity due to the amenities offered within (e.g., a snack bar, reclining seats, etc.). The difference in popularity may increase the demand for tickets at one theatre, thereby informing market data 120, for example.

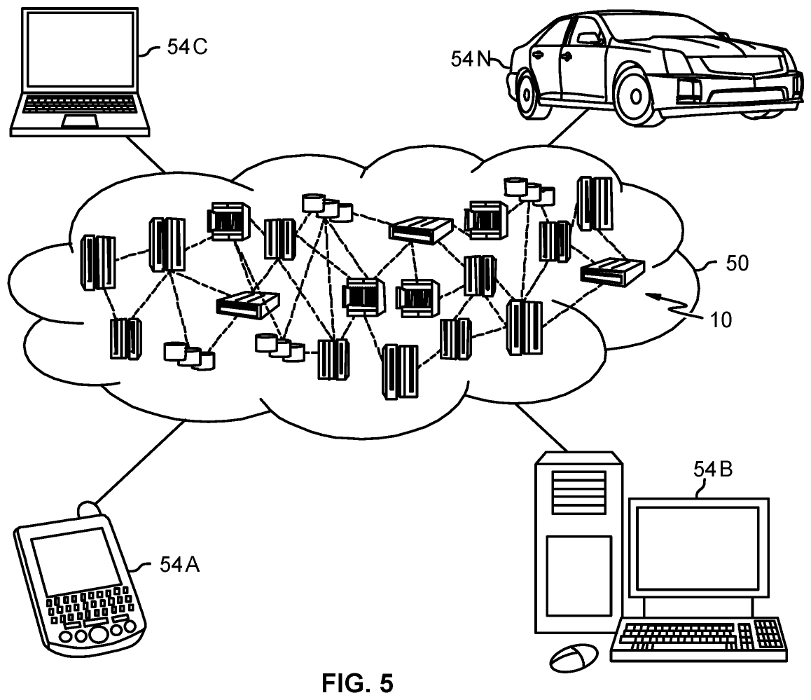

The data from the various data sources may be collected or sent to transfer controller 130. Transfer controller 130 may include profiler 140, risk evaluator 150, suggestor 160, and updater 170. Transfer controller 130 may be a single computing system, a virtualized system, or a collection of virtualized systems working in concert to fulfill the techniques described herein. Virtualized systems and cloud computing techniques are discussed in greater detail with regard to FIGS. 5 & 6.

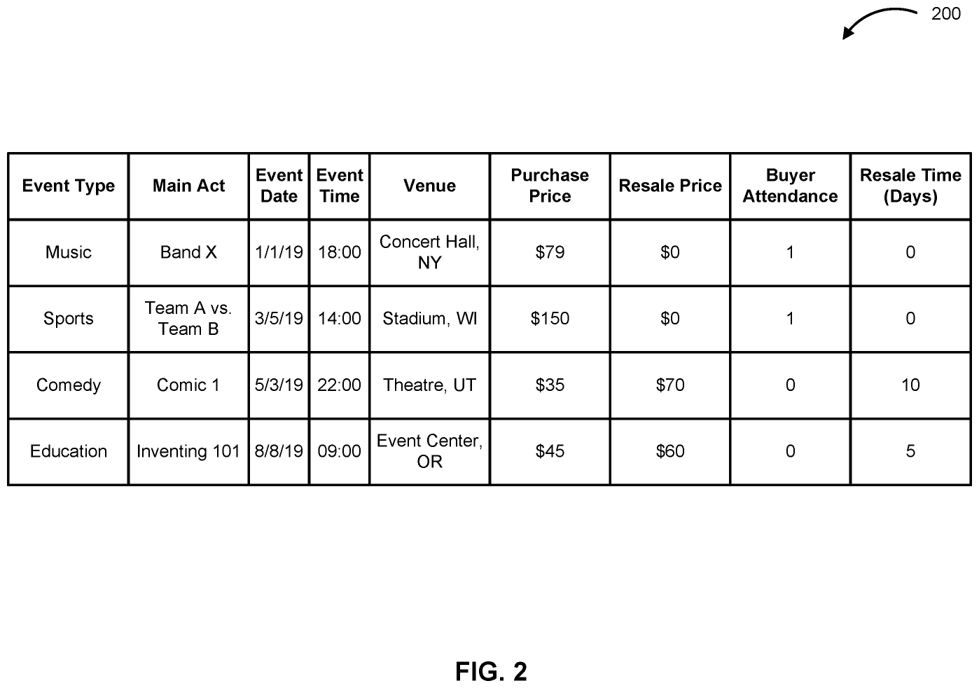

Profiler 140 may gather data from the various data sources to compile user profiles for managing electronic ticket transfers, as described herein. An example of a user profile is discussed in greater detail with regard to FIG. 2. In some embodiments, profiler 140 may compile profiles for venues and/or artists/teams/performers/etc. and/or for venues or other locations. In some embodiments, a plurality of types of profiles may be used in calculating a risk score for a user and/or a particular ticket transfer attempt.

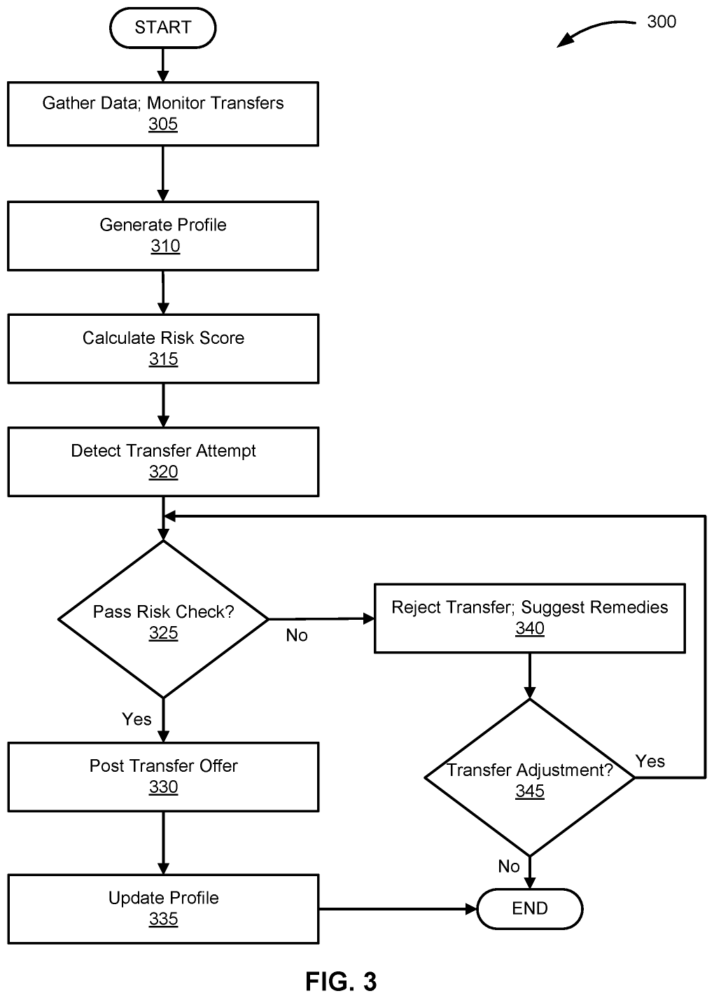

In some embodiments, information included in a profile may be sent to risk evaluator 150. Risk evaluator 150 may then consider the data included in the profile(s), as well as any data the risk evaluator 150 may infer and/or generate from the profile data, to generate a risk score for a user. The risk score for the user may be reflective of the reputation of the user, and/or the likelihood that the user has, or will, engage in ticket touting, price gouging, scalping, etc. Risk score generation is discussed in greater detail with regard to FIG. 3.

Risk Evaluator 150 may further perform a risk criteria check. A risk criteria check may use a set of risk criteria (e.g., price, quantity of tickets involved, number of resale attempts, number of sites involved in a resale attempt, risk scores associated with other users likely to purchase or accept the ticket transfer, etc.) to determine an acceptable range/value for each criterion, based on the risk score for the user. For example, a user with an “excellent” risk score (e.g., the user is trustworthy, has a good reputation, does not engage in price gouging, etc.) may have more freedom to set the parameters (e.g., price, number and type of sites to post the transfer offer to, number of tickets the user may post at a given time, the duration of the offer(s), the geographic range of sale, etc.) for a ticket transfer.

In contrast, a user with a “poor” risk score may have one or more parameters restricted. For example, a user with a history of price gouging may have a limited price range available, or a user with a history of being unable to sell all the tickets they post may be restricted to a lesser number of tickets and/or postings, etc.

In some embodiments, a risk score may dictate a risk criteria panel, without regard for the individual parameters and/or criteria. For example, a user with a “poor” risk score may have multiple, or even all, parameters for ticket transfers/resale attempts restricted. For example, a user with a “poor” risk score, due a history of price gouging, may be restricted by the number of tickets they may offer for transfer/resale, the other users to whom they may transfer tickets, the number and type of events they may resell, etc.

Risk evaluator 150 may pass information regarding the risk score(s) and risk criteria check(s) to suggestor 160. In embodiments, suggestor 160 may provide a user with an indication of how the current ticket transfer attempt will affect the risk score for the user. For example, if the user attempts to transfer a ticket with a very high resale price, the risk score associated with the user may be adversely affected, leading to restricted parameters in the future. In some embodiments where the risk criteria check is failed (e.g., the user attempts a ticket transfer using unacceptable parameters), the suggestor 160 may provide suggestions regarding which parameters must be adjusted, and what ranges for those parameters would lead to passing the risk criteria check.

Once the ticket transfer attempt passes the risk criteria check and the transaction is finalized, data regarding the transaction may be sent to updater 170. Updater 170 may amend the user profiles for all users involved in the transaction. Multiple user profiles may be updated concurrently using, for example Single Instruction, Multiple Data (SIMD) techniques for parallelism.

In some embodiments, transfer controller 130 may provide transaction data to, for example, sources of market data 120. In this way, market data 120 may be updated with real-time ticket transfer data. This may be particularly helpful in embodiments where multiple transfer controllers 130 are employed.

Referring now to FIG. 2, illustrated is an example of a user profile 200, in accordance with embodiments of the present disclosure. User profile 200 may be a table, as depicted here, or it may be a list, data tree, or any other suitable data organization type. In embodiments, user profile 200 may include fewer, the same, or more columns and/or rows than depicted here. As discussed herein, user profile 200 may include data gathered from various data sources (e.g., the data sources described in regard to FIG. 1), as well as data calculated/inferred/generated from the gathered data (e.g., price change). In embodiments, user profile 200 includes machine-readable (e.g., structured) data that may be directly used in the calculation of risk scores.

Referring now to FIG. 3, illustrated is a flowchart of a method 300 for managing electronic ticket transfer, in accordance with embodiments of the present disclosure. At 305, method 300 may gather data from data sources (e.g., the data sources discussed with regard to FIG. 1) and monitor ticket transfers. As described herein, gathering data and monitoring ticket transfers may provide the raw data needed for generating user profiles, calculating risk scores, performing risk criteria checks, and providing suggestions.

At 310, a user profile may be generated. As described herein, a user profile may contain information regarding the ticket transfers associated with a particular user. An example of a user profile is illustrated in FIG. 2.

At 315, a risk score may be calculated for the user. As described herein, a risk score may be used as an indicator of whether the user has a history (or a potential) of scalping/gouging/touting. In embodiments, a risk score may be calculated using a regression model using the purchase price, the resale price, the price change, and the duration of resale time to calculate a risk score for a user. For example, using a set of estimates derived from the model, a fitted logistic regression equation may be constructed: log(p/1−p)=0.22−0.005(Purchase Price)+0.014(Price Change)+0.006(Resale Price)+0.002(Resale Time).

In this example, values taken from the third row of the example user profile 200 of FIG. 2 can be used to provide the purchase price, price change, resale price, and resale time: log(p/1−p)=0.22−0.005(35)+0.014(35)+0.006(70)+0.002(5). Solving for “p” (e.g., the risk score for the user) provides a user risk score of 0.72.

At 320, a ticket transfer attempt is detected. In embodiments, this may include the creation of a resale posting by a user. The user may input parameters for the resale (e.g., resale price, duration for the posting to remain active, etc.).

At 325, a risk criteria check may be performed, as described herein. In embodiments, a risk criteria check may use the user risk score to determine a set of acceptable ranges or values for the parameters for resale and check the values the user input at 320 against these acceptable ranges/values to determine whether the ticket transfer attempt passes or fails the risk criteria check.

If, at 325, the ticket transfer attempt fails the risk criteria check, the transfer attempt may be rejected at 340, and remedies to prevent a future rejection may be sent to the user, as described herein.

At 345, it is determined whether the user has made any adjustments to the transfer attempt. If so, then the adjusted transfer attempt may be used to perform another risk criteria check (e.g., the method may flow to 325). If, however, the user makes no adjustments to the transfer attempt at 345, the method may end.

If the transfer attempt passes the risk criteria check at 325, the transfer attempt may be posted to the platform as an offer at 330. This may make the ticket transfer available for other users to browse and/or purchase. As discussed herein, there may be some restrictions to an allowed posting (e.g., a restricted set of users may purchase the ticket, the posting may be limited geographically, a price may be restricted, etc.).

At 335, the user profile for the user associated with the posting may be updated to include the information related to the posted ticket transfer offer.

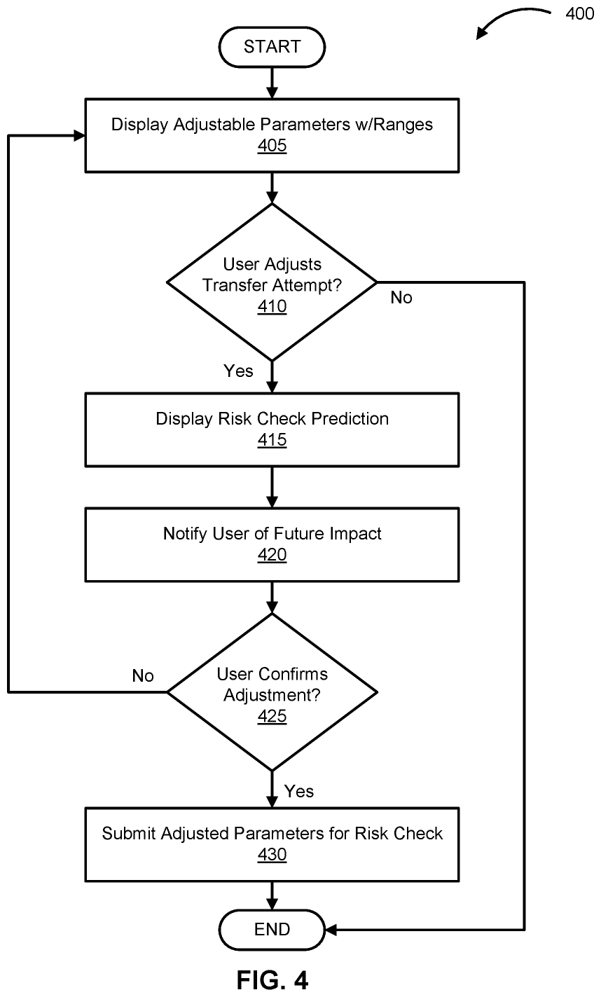

FIG. 4 illustrates a flowchart of a method 400 for adjusting a ticket transfer attempt, in accordance with embodiments of the present disclosure. In some embodiments, method 400 may take the place of operations 340 and 345 of FIG. 3. In some embodiments, method 400 may be employed at operation 320 of FIG. 3.

At 405, adjustable parameters for a ticket transfer attempt are displayed to a user, as described herein. This may include, for example, price, duration for the posting, etc., along with ranges/values that would make the transfer attempt pass a risk criteria check.

At 410, it may be determined whether the user adjusts the parameters of the transfer attempt (e.g., adjusts the asking price, adjusts the duration for the posting, the number of tickets for sale, the group of people to whom the sale is applicable, etc.).

If, at 410, the user does not adjust any parameters, the method 400 may end. However, in those embodiments where method 400 is not performed in response to a rejection/failure of a risk criteria check, the method 400 may, in some embodiments, proceed further (not shown).

If, at 410, it is determined the user has adjusted one or more parameters, a risk check prediction may be displayed at 415. The risk check prediction may allow the user to understand whether the new parameter values will result in passing the risk criteria check. In some embodiments, the risk check prediction may be displayed concurrently as the user adjusts the parameters.

At 420, the user is notified of the future impact of the current transfer attempt on the risk score associated with the user. In embodiments, the notification may provide the user with a concrete value for the new risk score, an adjustment indicator (e.g., the increase/decrease margin for the risk score), an arrow or other indicator illustrating the direction and severity of the impact, etc.

At 425, it may be determined whether the user confirms the adjustment of the parameters. In some embodiments, the user may use a touchscreen, a keyboard, mouse, voice activation, or any other suitable form of user interface.

If, at 425, the user does not confirm the adjustment, the method may proceed back to 405 to display the parameters and await further adjustment. If, however, the user does confirm the adjustment at 425, the adjusted parameters are submitted for a risk criteria check at 430, as described herein.

It is to be understood that although this disclosure includes a detailed description on cloud computing, implementation of the teachings recited herein are not limited to a cloud computing environment. Rather, some embodiments of the present invention are capable of being implemented in conjunction with any other type of computing environment now known or later developed.

Cloud computing is a model of service deliver for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources, but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure, but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities, but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

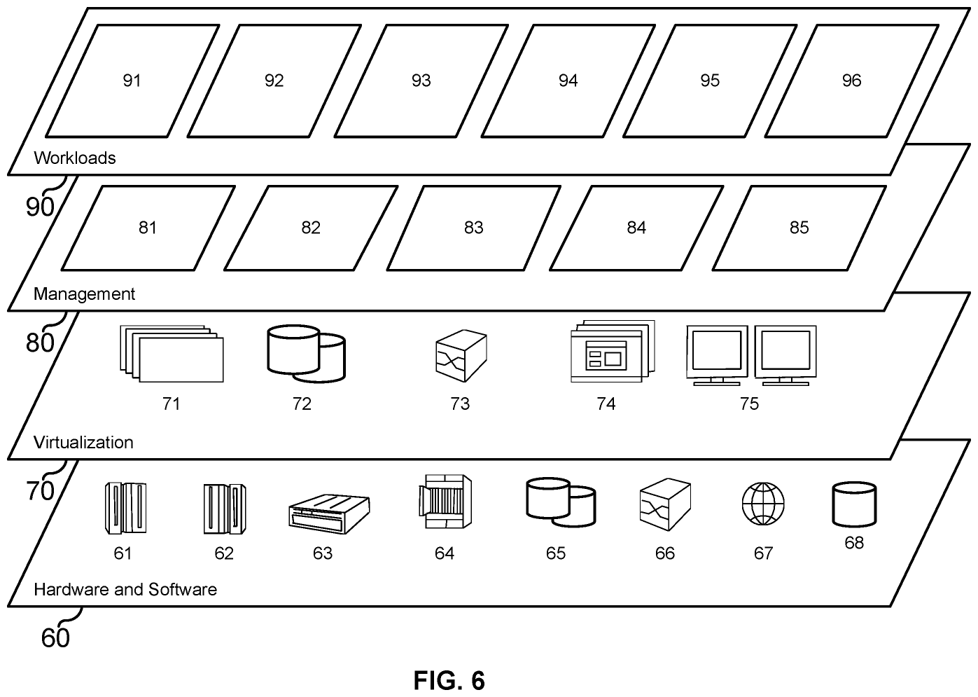

Referring now to FIG. 6, a set of functional abstraction layers provided by cloud computing environment 50 (FIG. 5) is shown. It should be understood in advance that the components, layers, and functions shown in FIG. 6 are intended to be illustrative only and some embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and managing electronic ticket transfer 96.

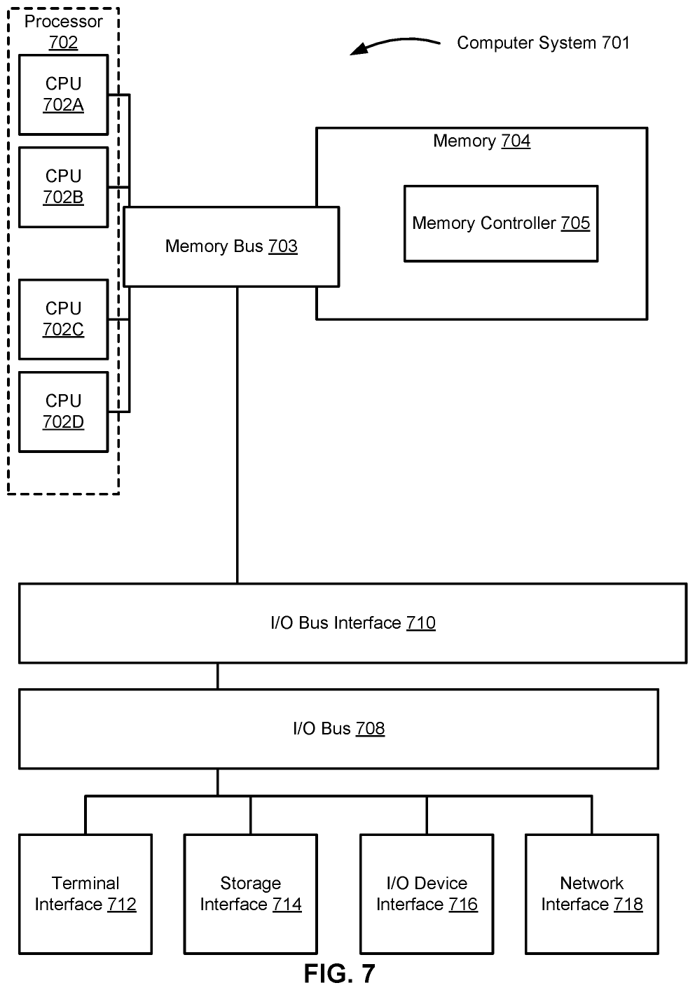

Referring now to FIG. 7, shown is a high-level block diagram of an example computer system 701 that may be configured to perform various aspects of the present disclosure, including, for example, methods 300 & 400, described in FIGS. 3 and 4, respectively. The example computer system 701 may be used in implementing one or more of the methods or modules, and any related functions or operations, described herein (e.g., using one or more processor circuits or computer processors of the computer), in accordance with some embodiments of the present disclosure. In some embodiments, the major components of the computer system 701 may comprise one or more CPUs 702, a memory subsystem 704, a terminal interface 712, a storage interface 714, an I/O (Input/Output) device interface 716, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other some embodiments the computer system 701 may alternatively be a single CPU system. Each CPU 702 may execute instructions stored in the memory subsystem 704 and may comprise one or more levels of on-board cache.

In some embodiments, the memory subsystem 704 may comprise a random-access semiconductor memory, storage device, or storage medium (either volatile or non-volatile) for storing data and programs. In some embodiments, the memory subsystem 704 may represent the entire virtual memory of the computer system 701, and may also include the virtual memory of other computer systems coupled to the computer system 701 or connected via a network. The memory subsystem 704 may be conceptually a single monolithic entity, but, in some embodiments, the memory subsystem 704 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 704 may contain elements for control and flow of memory used by the CPU 702. This may include a memory controller 705.

Although the memory bus 703 is shown in FIG. 7 as a single bus structure providing a direct communication path among the CPUs 702, the memory subsystem 704, and the I/O bus interface 710, the memory bus 703 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other some embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smart phone, mobile device, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to some embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various some embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various some embodiments of the present invention have been presented for purposes of illustration, but are not intended to be exhaustive or limited to the some embodiments disclosed. Many modifications and variations will be apparent to those of ordinary skill in the art without departing from the scope and spirit of the described some embodiments. The terminology used herein was chosen to best explain the principles of the some embodiments, the practical application or technical improvement over technologies found in the marketplace, or to enable others of ordinary skill in the art to understand the some embodiments disclosed herein.

What is claimed is:

1. A computer-implemented method for managing electronic ticket transfer, comprising:
monitoring a set of ticket transfer data associated with a user;
generating a user profile to store the set of ticket transfer data;
calculating a risk score for the user, based on the user profile;
detecting a ticket transfer attempt by the user;
determining the ticket transfer attempt meets a set of risk criteria, based on the risk score;
posting a ticket associated with the ticket transfer attempt for resale; and
updating the user profile, according to the ticket transfer attempt.

2. The method of claim 1, wherein the set of ticket transfer data includes an event type, a main act, a date, a time, a venue, a purchase price, a transfer price, an attendance indicator, and a transfer duration.

3. The method of claim 2, wherein the attendance indicator is based on comparing GPS data from a device associated with the user to GPS data associated with the venue, according to the date and the time.

4. The method of claim 3, wherein the user profile contains a set of additional data derived from the set of ticket transfer data.

5. The method of claim 4, wherein the set of additional data includes a price change, a transfer indicator, and a market value.

6. The method of claim 5, wherein calculating the risk score includes solving a fitted regression equation based on the purchase price, the transfer duration, the transfer price, and the price change.

7. The method of claim 6, wherein the method enables unilaterally provisioning computing capabilities in a cloud environment.

8. A computer program product for managing electronic ticket transfer, the computer program product comprising a computer readable storage medium having program instructions embodied therewith, the program instructions executable by a device to cause the device to:
monitor a set of ticket transfer data associated with a user;
generate a user profile to store the set of ticket transfer data;
calculate a risk score for the user, based on the user profile;
detect a ticket transfer attempt by the user;
determine the ticket transfer attempt meets a set of risk criteria, based on the risk score;
post a ticket associated with the ticket transfer attempt for resale; and
update the user profile, according to the ticket transfer attempt.

9. The computer program product of claim 8, wherein the set of ticket transfer data includes an event type, a main act, a date, a time, a venue, a purchase price, a transfer price, an attendance indicator, and a transfer duration.

10. The computer program product of claim 9, wherein the user profile contains a set of additional data derived from the set of ticket transfer data.

11. The computer program product of claim 10, wherein the set of additional data includes a price change, a transfer indicator, and a market value.

12. The computer program product of claim 11, wherein calculating the risk score includes solving a fitted regression equation based on the purchase price, the transfer duration, the transfer price, and the price change.

13. The computer program product of claim 9, wherein the attendance indicator is based on comparing GPS data from a device associated with the user to GPS data associated with the venue, according to the date and the time.

14. The computer program product of claim 13, wherein the computer program product enables unilaterally provisioning computing capabilities in a cloud environment.

15. A system for managing electronic ticket transfer, comprising:
a memory with program instructions included thereon; and
a processor in communication with the memory, wherein the program instructions cause the processor to:
monitor a set of ticket transfer data associated with a user;
generate a user profile to store the set of ticket transfer data;
calculate a risk score for the user, based on the user profile;
detect a ticket transfer attempt by the user;
determine the ticket transfer attempt fails a set of risk criteria, based on the risk score;
reject the ticket transfer attempt;
provide, to the user, one or more suggestions to remedy the rejection, according to the set of risk criteria;
in response to providing the one or more suggestions, receive, from the user, an adjustment to the ticket transfer attempt;
determine the adjusted ticket transfer attempt meets the set of risk criteria;
posting a ticket associated with the ticket transfer attempt for resale; and
updating the user profile, according to the adjusted ticket transfer attempt.

16. The system of claim 15, wherein the set of ticket transfer data includes an event type, a main act, a date, a time, a venue, a purchase price, a transfer price, an attendance indicator, and a transfer duration.

17. The system of claim 16, wherein the attendance indicator is based on comparing GPS data from a device associated with the user to GPS data associated with the venue, according to the date and the time.

18. The system of claim 17, wherein the user profile contains a set of additional data derived from the set of ticket transfer data.

19. The system of claim 18, wherein the set of additional data includes a price change, a transfer indicator, and a market value.

20. The system of claim 19, wherein calculating the risk score includes solving a fitted regression equation based on the purchase price, the transfer duration, the transfer price, and the price change.
